(19) United States
(12) Patent Application Publication
(10) Pub. No.: US 2024/0311627 A1
(43) Pub. Date: Sep. 19, 2024

(54) ON-CHIP LASER NEURON INTEGRATED ON SILICON

(71) Applicant: HEWLETT PACKARD ENTERPRISE DEVELOPMENT LP, Spring, TX (US)

(72) Inventors: BASSEM TOSSOUN, Santa Barbara, CA (US); DI LIANG, Santa Barbara, CA (US)

(21) Appl. No.: 18/183,781

(22) Filed: Mar. 14, 2023

(51) Int. Cl. G06N 3/067; G06N 3/048

(52) U.S. Cl. CPC G06N 3/067; G06N 3/048

(57) ABSTRACT

Systems, devices, and methods are provided for all-optical reconfigurable activation devices for realizing various activations. An example of the systems and methods disclosed herein includes operation of a nonlinear activation device using injection seeding to generate secondary optical signals based on injection locking using a seed signal and an optical power of the seed signal that exceeds a threshold. For example, the system and methods include adjusting a bias applied to an optical source comprising an optically active region positioned between Group III-V semiconductor material and receiving a first optical signal at a first wavelength that injection locks the optical source. The optical source emits a second optical signal at a second wavelength based on injection locking and generates one or more secondary optical signals based on: optical power of the first optical signal and the bias applied to the optical source.

### BACKGROUND

Driven by growing interest in artificial intelligence (AI), the global artificial neural network market is projected to grow at a significant rate. Artificial neural networks (ANN) and machine learning algorithms have the ability to learn from large data sets, which can create a machine having human-like decision making capabilities with low latency and high energy efficiency. Compared to electronic systems, neuromorphic photonics demonstrate improved performance in terms of multiplexing, energy dissipation, and crosstalk, which are beneficial for dense and high-bandwidth interconnects. Consequently, the neuromorphic photonic systems potentially offer operating speeds that are several orders of magnitude faster than neuromorphic electronics, along with higher efficiency.

ANNs are neuromorphic computing systems inspired by biological neural networks. The neuromorphic systems consist of a collection of connected nodes or neurons. Each neuron includes linear weights, a summation, and a nonlinear activation, which is a building block in ANNs that enables complex mappings between inputs and outputs for learning tasks. Several nonlinear activation functions, such as sigmoid, radial-basis, rectified linear unit (ReLU), and quadratic functions to name a few, are widely used in ANNs for different machine learning tasks.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates a model of an example nonlinear neuron, which includes synapses, weighted addition, and a nonlinear activation function in accordance with implementations disclosed herein.

FIG. 2 depicts a schematic diagram of an optical device in accordance with implementations disclosed herein.

FIG. 3A illustrates an example optical response of an example implementation of the optical device of FIG. 2 before injection seeding by a master lasing mode.

FIG. 3B illustrates an example optical response of the example implementation of the optical device of FIG. 2 after injection seeding by a master lasing mode.

FIG. 4 depicts a graphical representations of a normalized nonlinear activation function as a function of input optical power in accordance with an example implementation disclosed herein.

FIGS. 5A and 5B illustrate another example optical device according to an implementation disclosed herein.

FIG. 6 illustrates a schematic diagram of an example system architecture for a neuron according to implementations disclosed herein.

FIG. 7 is an example neural network demonstration using the system architecture of FIG. 6.

FIG. 8 is an example computing component that may be used to operate a nonlinear activation function in accordance with the implementations disclosed herein.

FIG. 9 is an example computer system that may be used to implement various features of all-optical nonlinear activation devices of the present disclosure.

The figures are not exhaustive and do not limit the present disclosure to the precise form disclosed.

### DETAILED DESCRIPTION

As described above, ANNs and machine learning algorithms, implemented as neuromorphic computing system, have the ability to learn from large data sets to create human-like machines. Each neuron of a neuromorphic computing system consists of a linear weighting of inputs, summation and a nonlinear activation function that achieves complex mappings between inputs and outputs for learning. Example nonlinear activation functions include, but are not limited to, sigmoid, radial-basis, ReLU (such as ReLU, inverse ReLU, and leaky ReLU), and quadratic functions, each of which is used in signal processing for different machine learning tasks. The various nonlinear activation functions are suitable for different tasks in neural networks and machine learning applications. For example, ReLU functions can provide for solving nonlinear optimization problems with constraints, and can be used in feedforward machine learning networks, such as multi-layer perceptron and convolutional neural networks. Other examples include radial-basis functions used for multi-layers based on support vector machines and quadratic functions used to simulate higher-order polynomial neural networks.

In order to achieve nonlinear activation, various approaches have been applied. Generally, these approaches can be divided into two types—an optoelectronic approach, and an all-optical approach. In optoelectronic approaches, nonlinear schemes integrated with photodetectors have been demonstrated based on a silicon microring modulator, a Mach-Zehnder modulator (MZM), an electro-absorption modulator, and a laser. However, these optoelectronic approaches are all subject to technical shortcomings, for example, all these approaches require efficient and fast optic-electro-optic (O-E-O) conversion. These requirements almost always lead to increased system complexity and additional power consumption from electronic devices, such as complementary metal-oxide-semiconductor (CMOS) field effect transistors. For example, each O-E-O conversion may consume between 0.1 pJ and 1 pJ of energy.

With the development of nonlinear optics, some all-optical methods of implementing activation functions have been proposed due to data parallelization capabilities, high bandwidth, and energy efficiency offered by photonic neuromorphic platforms. However, in current implementations, the nonlinear activation function is typically provided on separate chip from the rest of the neural network, whether the neuromorphic system is electronic or photonic. This causes a data bottleneck, commonly known as the von Neumann bottleneck, in which the data transferred between the chips is limited by the interconnect data capacity and bandwidth. Energy requirements and costs also increase as the separate chip generally requires O-E-O conversions.

Implementations disclosed herein relate to devices and methods for providing an all-optical non-linear activation function that can be integrated directly on the same chip (e.g., a common substrate) as a photonic neural network. As a result, energy costs due to O-E-O conversions and data bottlenecking can be reduced, if not completely avoided. Implementations of the present disclosure provide for an optical device formed on a hybrid Group III-V-on-Si platform (referred to herein as a “hybrid Si platform”) that can be driven to provide a nonlinear activation function. The optical device according to implementations disclosed herein comprises an optically active region disposed between bonded semiconductor layers comprising Group III-V semiconductor material. Group III-V semiconductor materials include, but are not limited to, gallium arsenide (GaAs), indium phosphide (InP), or other compounds of indium, gallium, phosphorus, and arsenic. The optically active region comprises, for example, quantum dot (QD), quantum wells (QW), quantum-dash (QD) structures, or any structure that can create carrier population inversion for optical gain. The semiconductor layers and optically active region are formed on a waveguide of a resonator cavity. A bias current can be applied to the semiconductor layers to drive the optical device and cause the optical active region to generate an optical signal. Generated light is injected into the waveguide and resonates in the resonator cavity to create lasing conditions. A lasing mode within the waveguide can be evanescently coupled into and out of the waveguide from a bus waveguide.

Optical sources in accordance with the implementations disclosed herein can operate in spontaneous emission or stimulated emission based on the bias current applied to the semiconductor layers. At a threshold amplitude of the bias current, the optical response of the optical device shifts from spontaneous emission into stimulated emission. While operating in stimulated emission, secondary modes can be excited by injecting locking the optical device using a pump laser emitting an optical signal at or above a threshold optical power. For example, while the optical device is driven in stimulated emissions, the pump laser can inject a first optical signal (e.g., a first lasing mode, or also referred to as a master lasing mode) at a first wavelength into the optical device. The first optical signal acts functions as a seed signal that injection locks the optically active region of the optical device to generate a second optical signal (e.g., second lasing mode or a slave lasing mode). In response to the optical power of the first optical signal increasing to the threshold optical power, one or more secondary optical signals (e.g., secondary modes) are excited within the optically active region at one or more wavelengths that differ from the first and second wavelengths. The secondary optical signal resonates within the resonator cavity, couples into the bus waveguide, and is output from the optical device.

The implementations disclosed herein leverage the appearance of the one or more secondary optical signals to provide for nonlinear activation of a neuron. For example, an input into the optical device of the present disclosure can be based on a weighted sum of valued input into a neuron. That is, an input optical signal may have a wavelength and optical power corresponding to the weighted sum. As the weighted sum approaches conditions to activate the neuron, the optical power of the input optical signal can increase. Once conditions to activate the neuron are met, which means the optical power of the input optical signal may be at the threshold optical power, the one or more secondary modes may be excited, thereby activating the neuron due to the sudden, nonlinear appearance of the secondary modes.

Accordingly, implementations disclosed herein provide an all-optical approach that can be heterogeneously integrated directly on a common substrate (e.g., on the same chip) as other components of a neural network. For example, a neuron can be provided comprising the optical device in accordance with the implementations disclosed herein integrated on a substrate on which optical implementations of the matrix multiplication (e.g., matrix vector multiplication, general matrix matrix multiplication, or the like). The input into the neuron may be a pump laser or prior neuron which outputs a decision to the neuron. Furthermore, in some implementations, the output from the neuron may function as an input to a next neuron, for example, the output optical signal of a decision from the neuron may be an input optical signal into the next neuron. The common substrate may comprise one or more of the cascaded neurons to provide an all-optical neuromorphic system.

The implementations disclosed herein can provide numerous non-limited advantages over conventional approaches. For example, implementations disclosed herein can integrate optical data communication links seamlessly with the memory within a computation system. This provides for increased data transfer rates and more energy-efficient data storage and transmission, through the use of photonics. Additionally, components of computational systems (e.g., processors, interconnects, and memory) can all be integrated onto a single common optical chip. Implementations disclosed herein can be easily integrated into the silicon photonics platform, such as but not limited to, hybrid Si platforms, and will be fundamental building blocks for circuits and applications in optical computing. Implementations disclosed herein can be complementary metal-oxide semiconductor (CMOS) compatible, which provides for high-volume, low-cost manufacturing.

Furthermore, implementations disclosed herein can be used to produce optical neural networks and optical field programmable gate arrays (FPGAs), which can be implemented into neuromorphic computing systems for deep learning and artificial intelligence. The photonic-based approach disclosed herein enables increased bandwidth and reduced-energy consuming methods for neuromorphic computing systems as compared to conventional electronic approaches. Thus, the implementations disclosed herein can more closely align to the energy-efficiency and processing power of the human brain.

It should be noted that the terms “optimize,” “optimal”, and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

As used herein “approximately” and “generally” refer to permissible variations in properties of the implementations disclosed herein. Implementations disclosed herein may have certain properties, attributes, and/or characteristics that include some acceptable variation that does not significantly affect the functioning of the disclosed implementations.

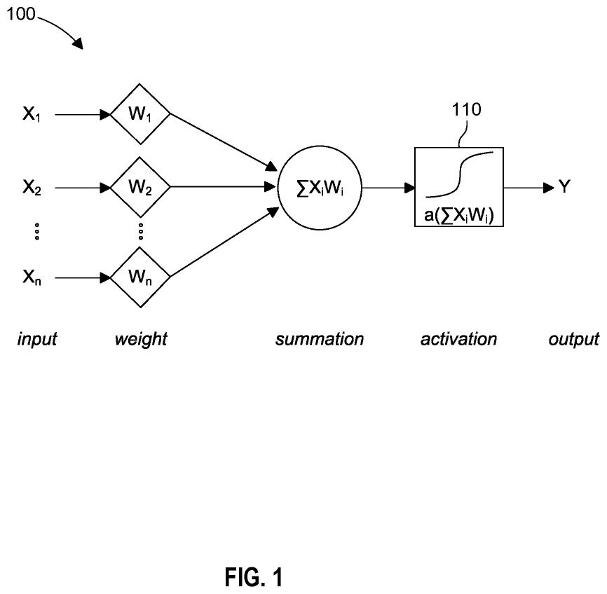

FIG. 1 illustrates an example neuron 100 of an ANN, where the inputs (e.g., X₁ to Xₙ) into the neuron are a linear combination (weighted addition) of the output of other neurons. This neuron applies weights (e.g., W₁ to Wₙ) to the input signals, aggregates (e.g., by summation) the weighted signals over time to provide a weighted summation. The weighted summation is input into a nonlinear activation function 110 that produces a nonlinear response Y. The activation function 110 may be implemented according to implementations disclosed herein. The neuron's output is then broadcast to successive neurons in the ANN. Note that the inter-neuron connections can be weighted with positive and negative values represented as excitatory and inhibitory synapses, respectively. The synaptic interconnection network of neurons can be represented as a matrix of the weight values (Wᵢⱼ) or real numbers. Moreover, the coding scheme will map the real-valued weights and represent them as spiking signals.

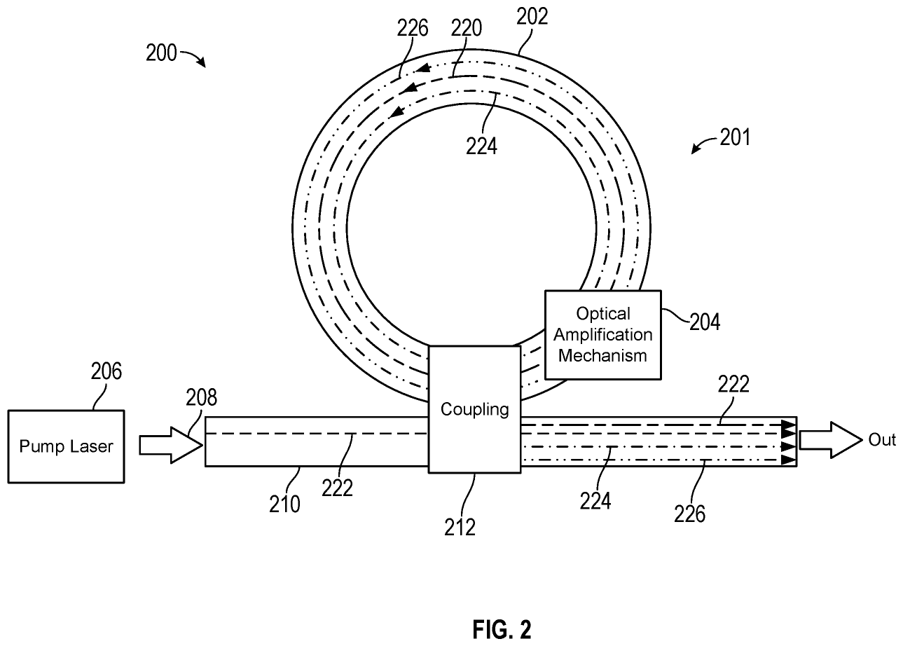

FIG. 2 depicts a schematic diagram of an optical device 200 in accordance with implementations disclosed herein. The optical device 200 can be an example of a physical implementation of activation function 110 of FIG. 1, in which case optical device 200 may be referred to as a nonlinear activation device. In some examples, some or all of the elements of the optical device 200 may be part of a photonic neuromorphic system, for example, optical device 200 may be formed of silica, silicon, or other Group IV material (e.g., germanium, silicon carbide, silicon germanium, and so on) platform and provided on a common substrate with one or more other parts of a photonic neuromorphic system. In some examples, the optical device 200 may be formed using Group III-V materials.

The optical device 200 comprises a resonator structure 201 (also referred to as a resonator cavity) and a bus waveguide 210 that receives an input optical signal 208. In the example of FIG. 2, the bus waveguide 210 receives input signal 208 from a pump laser 206. However, in some implementations, input signal 208 may be received from a preceding component of a neuromorphic system, such as an output of a weighted summation of a neuron.

The resonator structure 201 includes a waveguide 202 optically coupled to the bus waveguide 210. The waveguide 202, according to the illustrative example of FIG. 2, may be a closed loop formed of semiconductor material, such as silicon or other Group IV material. The shape of the loop may be, for example but not limited to, circular, elliptical, a racetrack shape, etc., thereby forming a ring resonator or cavity. In another example, the resonator structure 201 may be implemented as a Fabry-Perot type of resonator cavity. Resonator structure 201 may have a plurality of resonance frequencies separated by an integer of free spectral ranges (FSRs) of the resonator structure 201. As a result, resonator structure 201 resonantly amplifies optical signals propagating in the resonator structure 201 that are aligned with any one of the resonance frequencies.

The resonator structure 201 also comprises an optical gain mechanism 204 coupled to the waveguide 202. The optical gain mechanism 204 is configured to generate optical signal 220 aligned with a resonance frequency of the resonator structure 201. That is, optical signal 220 has a wavelength corresponding to a resonance frequency of resonator structure 201 (referred to herein as a resonance wavelength). In some examples, optical signal 220 may be aligned with a central resonance wavelength of the resonator structure 201. According to various illustrative implementations, the optical gain mechanism 204 comprises an optically active region, such as but not limited to, quantum dots (QD), quantum wells (QW), quantum-dash structures, or any structure that can create carrier population inversion for optical gain in the waveguide. In these implementations, the optical gain mechanism 204 can generate an optical signal based on a bias current applied thereto, thereby spontaneously stimulating emission (e.g., photoluminescence). For example in the case of quantum dots, the optically active region generates optical signal 220 at a wavelength corresponding to the energy difference between conductance band and valence band or the transition between discretized energy states. This state of operation is referred to herein as spontaneous emission operation. As the bias current applied approaches a threshold bias current (e.g., corresponding to a threshold current), operation shifts from spontaneous emission to stimulated emission operation. In stimulated emission operation, optical signals resonating in waveguide 202 create lasing conditions, during which the optical signals act as seed signals that force the optical gain mechanism 204 to emit a lasing mode at the frequency of the seed signal. In an example, optical signal 220 may be an example of a lasing mode generated by optical gain mechanism 204 while optical device 200 is operated in stimulated emission. An example optical gain mechanism 204 is described below in connection with FIG. 2, which may be operated in stimulated and/or spontaneous emission operation.

Input optical signal 208 propagates in bus waveguide 210 as optical signal 222, which can evanescently couple into and/or out of waveguide 202. As described above, may have a plurality of resonance frequencies separated by an integer of free spectral ranges (FSRs) of the resonator structure 201. When the input signal 208 is aligned with a resonance frequency of resonator structure 201, input signal 208 can be coupled into the waveguide 202 to resonant therein and/or out of waveguide 202 into the bus waveguide 210. In some implementations, input signal 208 can be coupled into/out of waveguide 202 based on a coupling ratio corresponding to a distance between the waveguide 202 and bus waveguide 210. In other implementations, an optical coupler 212 may be provided to couple light into and/or out of bus waveguide 210. The optical coupler 212 may be, for example, but not limited to, a Mach-Zehnder interferometer, directional coupler, or the like.

According to various implementations, optical signal 222 can function as a seed signal when the optical gain mechanism 204 is in stimulated emission operation. For example, optical signal 222 may be evanescently coupled into the waveguide 202 and injected into optical gain mechanism 204. While operating in stimulated emission, optical signal 222 may injection lock the optical gain mechanism 204. As a result, optical signal 222 operates as a seed signal and forces optical gain mechanism 204 to emit optical signal 220. Conventionally, a seed signal forces an injection-locked laser to emit at a frequency of the seed signal. However, implementations disclosed herein operate such that the optical signal 222 forces optical gain mechanism 204 to emit optical signal 220 at a different frequency than the seed signal, as described below. Such operation can be attributed to the implementation of the optical gain mechanism 204 utilized in optical device 200.

For example, one or more secondary modes can be excited in the optical gain mechanism 204 if the optical power of the optical signal 222 is above a threshold optical power. As noted above, optical signal 222 propagates at a first wavelength (e.g., a first lasing mode, which may be referred to here as a master lasing mode), which may cause the optical gain mechanism 204 to generate optical signal 220 at a second wavelength (e.g., a second lasing mode, which may be referred to here as a slave lasing mode) while optical gain mechanism 204 is in stimulated emission. If the optical power of the second optical signal 222 increases to or above the threshold optical power, one or more secondary modes may be excited in optical gain mechanism 204, which propagate in resonator structure 201. The operation, where secondary modes are excited when the optical power of the seed signal exceeds a threshold, may be referred to herein as injection seeding. In an illustrative example, a first secondary mode may be generated as optical signal 224 and a second secondary mode may be generated as optical signal 226 at wavelengths different from the first lasing mode and the second lasing mode. The optical signals 224 and 226 may align with resonance frequencies of the resonator structure 201, so to resonant within the resonator structure 201 and evanescently couple to the bus waveguide 210.

Optical signals propagating in bus waveguide 210 can be output from the bus waveguide 210 at an output end opposite an input end into which input signal 208 is emitted. While operating in stimulated emission, the output comprises the optical signals 220 and 222 (e.g., first and second lasing modes). If the optical power of optical signal 220 is equal to or above the threshold optical power, the output also comprises the optical signals 224 and 226 (e.g., the first and second secondary modes). At the output end of the bus waveguide 210, an optical coupler, or the like, may optionally be provided to facilitate coupling the output light, for example, to downstream components of the neuromorphic system.

In operation, the optical power of input signal 208 may be based on a weighted summation of a neuron comprising optical device 200. The bias current bias above the threshold bias current may be applied to the optical device 200 to drive the optical gain mechanism 204 in stimulated emission. When the weighted summation (ΣXᵢWᵢ of FIG. 1) reaches conditions to activate the neuron the optical power of input signal 208 is increased so to input signal 208 at an optical power equal to or above the threshold optical power. Responsive to these conditions, secondary modes are excited in optical gain mechanism 204 and are emitted as optical signals 224 and 226. One or more of the secondary modes may be used as a nonlinearity output (e.g., γ of FIG. 1) that can be used as decision of the neuron. Downstream components of the neuromorphic system can use the sudden, nonlinear increase in optical power at wavelengths corresponding to one or more of secondary modes as an input. For example, as an input Xₙ of FIG. 1 into a subsequent neuron.

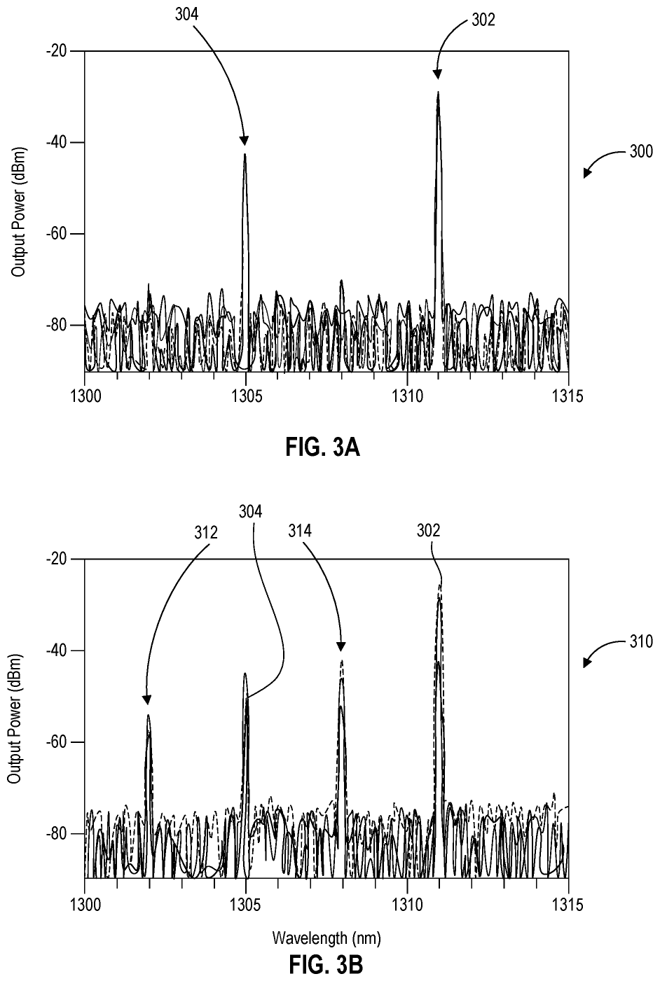

FIG. 3A illustrates an example optical response 300 of an example implementation of the optical device 200 before injection seeding by a master lasing mode. Injection seeding causes the secondary modes to be excited does not occur until sufficient optical power from the master laser is reached, as shown in FIG. 3B. That is, optical response 300 illustrates a case where a bias current is applied to optical device 200 so to operate in stimulated emission and thus injection locking optical gain mechanism 204, but the optical power of optical signal 220 is below the threshold optical power for injection seeding. Optical response 300 is provided as output optical power as a function of wavelength measured at the output end of bus waveguide 210. The optical response 300 comprises a first lasing mode 302 (e.g., master lasing mode) of optical signal 220 and second lasing mode 304 (e.g., slave lasing mode) generated by the optical gain mechanism 204. The first lasing mode 302 may comprise a first wavelength, while the second lasing mode 304 comprises a second wavelength.

FIG. 3B illustrates an example optical response 310 of the example implementation of the optical device 200 after (e.g., during) injection seeding by a master lasing mode. That is, optical response 310 illustrates a case where a bias current is applied to optical device 200 so to operate in stimulated emission, and the optical power of optical signal 220 is equal to or above the threshold optical power. Optical response 310 is provided as output optical power as a function of wavelength measured at the output end of bus waveguide 210. The optical response 310 comprises the first lasing mode 302 and the second lasing mode 304 of optical response 300. The optical response 310 also shows the first and second secondary modes 312 and 314 of optical signals 224 and 226 that appear responsive to the optical power of optical signal 220 being increased above the threshold optical power. As shown in FIG. 3B, the wavelengths of the first and second secondary modes 312 and 314 differ from the wavelengths of the first and second lasing modes 302 and 304, respectively.

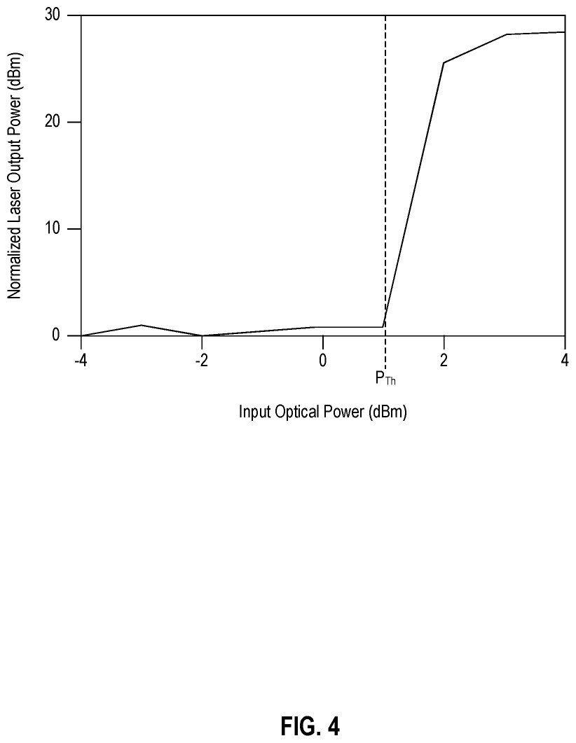

FIG. 4 depicts a graphical representation of a normalized nonlinear activation function as a function of input optical power in accordance with an example implementation disclosed herein. FIG. 4 illustrates output optical power as a function of input optical power according to the example implementation of optical device 200 for obtaining a sigmoid activation function as an example. Normalized output optical power of one of optical signals 224 and 226 (e.g., one of the secondary modes) at the output end of bus waveguide 210 is observed as a function of input optical power of optical signal 220. That is, FIG. 4 illustrates the effect of input optical power of optical signal 220 to cause optical device 200 to generate one or more secondary modes at a threshold optical power P_{Th}. In the example implementation of FIG. 4, the threshold optical power is approximately 1 dBm, such that a sudden increase of optical power at a wavelength corresponding to one of the secondary modes is observed between input optical power 1 dBm and 2 dBm. An optical power of 1 dBm shown in FIG. 4 is an illustrative threshold obtained through simulation of an example implementation of optical device 200. Other threshold optical powers are applicable depending on the specific configuration and structures used to implemented optical device 200.

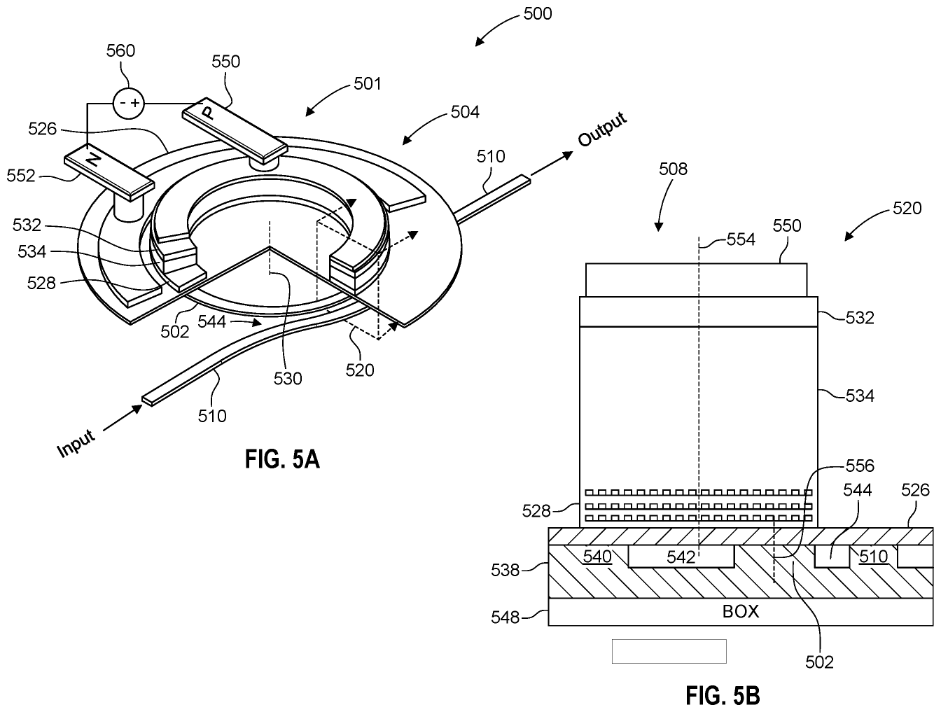

FIGS. 5A and 5B illustrate an example optical device 500 according to an implementation disclosed herein. FIG. 5A illustrates a perspective view of the optical device 500 and FIG. 5B illustrates a cross-sectional view of the optical device 500 taken along the plane 520. Optical device 500 is an example implementation of the resonator-based optical device 200 of FIG. 2 as a microring resonator (MRR). Optical device 500 includes a resonator structure 501 as a MRR comprising a waveguide 502 optically coupled to a bus waveguide 510 via evanescent optical coupling. The resonator structure 501 and waveguide 502 are example implementations of resonator structure 201 and waveguide 202, respectively, and bus waveguide 510 is an example implementation of bus waveguide 210. Thus, as described above in connection with FIG. 2, evanescent coupling may be achieved via an optical coupler, such as optical coupler 212. Additionally, the waveguide 502 may be a closed loop structure around a central axis 530 having a shape that is circular, thereby forming a ring resonator or cavity. However other shapes are possible, for example but not limited to, elliptical, a racetrack shape, etc. Light may be input into a first end of the bus waveguide 510 (e.g., input signal 208) and light is output from the second end of the bus waveguide 510. In various implementations, the waveguide 502 and bus waveguide 510 may be formed of a semiconductor material, such as silicon or other Group IV material.

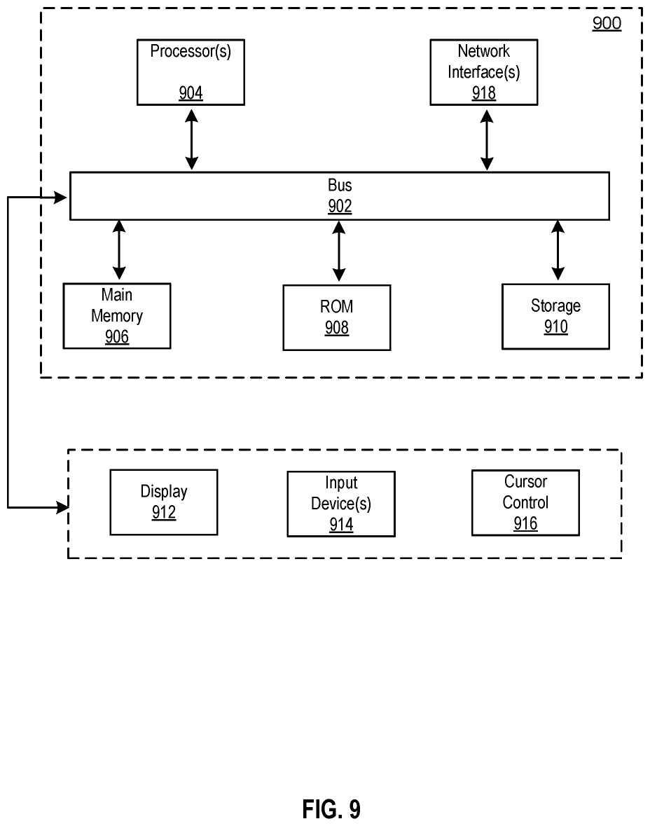

The resonator structure 501 comprises an optical gain mechanism 504 configured to generate light aligned with a resonant frequency of the waveguide 502, which is injected into the waveguide 502 and resonates therein. The optical gain mechanism 504 is an example implementation of the optical gain mechanism 204 of FIG. 2. Light propagating in the waveguide 502 may be coupled to the bus waveguide 510 and/or used as seed signal for self-seeding of the optical gain mechanism 504 (e.g., spontaneous emission operation). Light may be generated by the optical gain mechanism 504, for example, by applying a bias current to contact electrode 550 and 552 (e.g., via power source 560 controlled by a computing device, such as computing system 9 of FIG. 9), which causes an optically active region 528 to photoluminescent and inject light into the waveguide 502.

The bias current may be modulated to drive the operation of optical gain mechanism 504 into stimulated emission. For example, responsive to the bias current modulated beyond the threshold bias, operation shifts from spontaneous emission to stimulated emission. While operating in stimulated emission, light propagating in waveguide 502 acts as a seed signal that forces the optical gain mechanism 504 to emit additional light, for example, at a lasing mode of the optically active region 528, thereby providing for injection locking from the input light source (e.g., master laser 206). As described above, the lasing mode of the optically active region 528 may be the slave lasing mode.

In the illustrative example of FIGS. 5A and 5B, the optical gain mechanism 504 includes a buried oxide (BOX) layer 548 grown on a substrate (not shown), for example, such as a silicon dioxide layer. The optical gain mechanism 504 also comprises a layer 538 of semiconductor material formed on the BOX layer 548. The semiconductor material layer 538 may be a silicon layer or layer of other Group IV materials, according to some examples. In another example, material layer 538 may comprise one or more Group III-V materials. The semiconductor material layer 538 comprises the waveguide 502 and bus waveguide 510 formed therein and separated from each other via trench 544 (e.g., an air trench or air gap). A structure 540 may also be formed in the semiconductor material layer 538 for supporting a central portion of the optical gain mechanism 504. The structure 540 is formed on a side of the waveguide 502 opposite the bus waveguide 510, having a trench 542 therebetween. The trench 542 and 544 may function to confine the optical mode within the waveguide 502 in the lateral direction. In various implementations, the waveguide 502 may be a single mode waveguide. Light propagating in waveguide 502 may be evanescently coupled into the bus waveguide 510 via the trench 544, for example, as a directional coupler in this example. The BOX layer 548 may be provided to confine the optical mode in a longitudinal direction (e.g., into the layers provided on the BOX layer 548). Control of the width of the trench 544 may alter the coupling ratio between the waveguide 502 and bus waveguide 510 (e.g., a larger width results in a smaller coupling ratio).

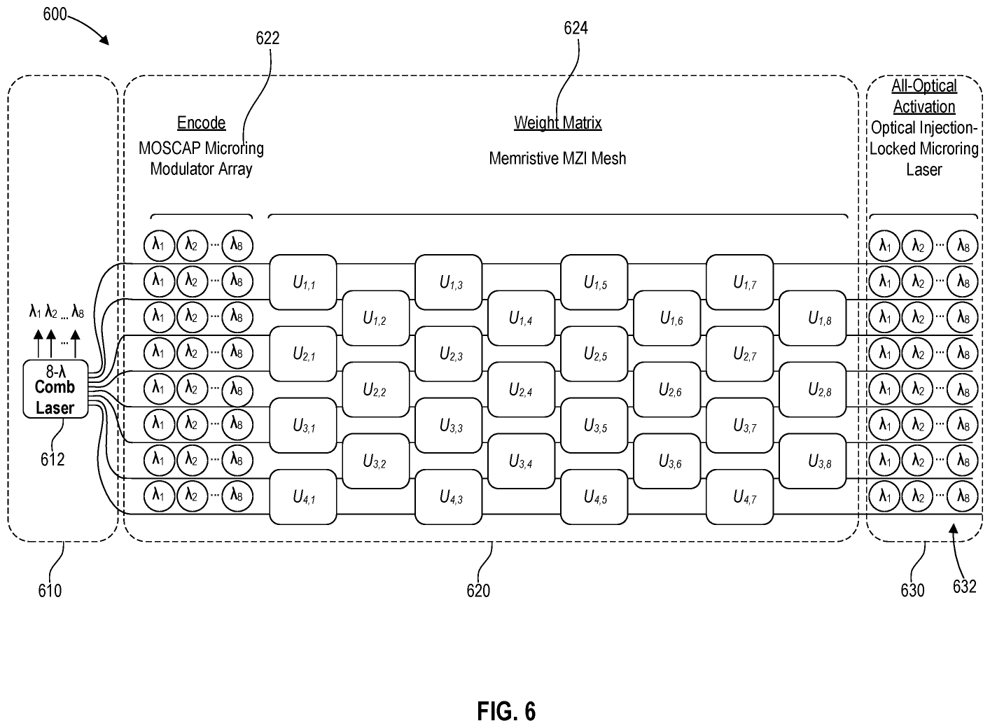

The optical gain mechanism 504 includes a cathode 526 comprising a first material and a portion of which is formed on a side of the semiconductor material layer 538 opposite the BOX layer 548. The cathode 526 contacts at least the waveguide 502 and the bus waveguide 510 and is electrically coupled to the contact electrode 552. An interface may be positioned between the waveguide 502 and the cathode 526 at which carrier concentration may change due to bias current applied to the electrodes 550 and 552. In some implementations, the cathode 526 may contact the waveguide 502, as shown in FIG. 5B, providing for the interface. In other example, as described in connection with FIGS. 6-13, a thin layer comprising Group III-V oxides may be formed as the interface between the cathode 526 and the waveguide 502.

The optical gain mechanism 504 also comprises a mesa structure 508 formed on cathode 526. The mesa structure 508 is provided for generating light, which is provided to the waveguide 502 based on applying a bias current between contact electrodes 550 and 552. A bias applied to the mesa structure 508 may act to modulate operation between spontaneous emission and stimulated emission. The mesa structure 508 overlaps at least the waveguide 502 in the longitudinal direction. A central longitudinal axis 554 of the mesa structure 508 may be offset from a central longitudinal axis 556 of the waveguide 502 in a direction toward the central axis 530.

The mesa structure 508 includes an anode 532 formed on a doped semiconductor material layer 534, which is disposed on an optically active region 528 formed on the cathode 526. The contact electrode 550 is disposed on the anode 532 opposite the cathode 526 in the longitudinal direction. The doped semiconductor material layer 534 comprises a second material that is dissimilar from the first material. The cathode 526 spans trench 544 and trench 542 formed in the semiconductor material layer 538. The trenches 542 and 544 may function to confine the optical mode in the lateral direction and the lateral width of trench 544 may be selected to control the coupling between waveguides 502 and 510.

In various implementations, the cathode 526 comprises a layer of Group III-V material as the first material, such as gallium arsenide (GaAs), indium phosphide (InP), or other compounds of indium, gallium, phosphorus, and arsenic. The cathode 526 may be formed by, for example but not limited to, deposition, wafer bonding, monolithic growth, or other fabrication techniques. The anode 532 may comprise a layer of Group III-V material that is oppositely dopped as the cathode III-V as the second material. For example, the cathode 526 may be a negatively-doped material (e.g., a n-doped semiconductor layer comprising Group III-V material) as the first material, and the anode 532 may be a positively-doped material (e.g., a p-doped semiconductor layer).

As described above, the mesa structure 508 is configured to generate light and induce optical gain in the waveguide 502. For example, optical gain may be achieved by light-emission generated within the mesa structure 508 while under spontaneous emission operation, which produces light that can be injected into the waveguide 502. By biasing the voltage applied to the mesa structure 508, operation can be shifted to stimulated emission, during which an input light functions as a seed signal for injection locking the optical gain mechanism 504 to the frequency of the slave mode. The mesa structure 508 then operates to emit light at the wavelength of the slave mode based on injection seeding by light input into the waveguide 502.

To achieve spontaneous and/or stimulated light emission, the optically active region 528 is disposed in the doped semiconductor material layer 534 adjacent to the cathode 526. In some implementations, doped semiconductor material layer 534 may be grown optically active region 528, such that the layers are monolithic. The optically active region 528 may comprise, for example, quantum dot (QD), quantum wells (QW), quantum-dash (QD) structures, or any structure that can create carrier population inversion for optical gain as an optical gain medium. In an example, the optically active region 528 may comprise InAs and/or GaAs QDs. The doped semiconductor layer 534 comprising the optically active region 528 may be formed of a doped Group III-V material, such as AlGaAs or the like, which is doped to a polarity opposite to that of the cathode 526 (e.g., positively-doped Group III-V material) as the second material.

To generate light, a bias current may be applied between the electrodes 550 and 552. The bias causes a carrier concentration change through accumulation that leads to emission in the optically active region 528, thereby generating light. Emitted light traverses the layers and is injected into the waveguide 502, in which the light then propagates.

When optical power of the input light is equal to or exceeds a threshold optical power, one or more secondary modes are excited within the optical gain mechanism 504, which emits the one or more secondary modes into the waveguide 502. The one or more secondary modes resonant in waveguide 502, thereby providing a nonlinear response to an input signal. One example mechanism for injection seeding may be that input light injected at one wavelength may cause stimulated emission at different wavelengths. In the case of QD, the optically active region 528 may comprise carriers that can be stimulated at different modes based on a common input wavelength. That is, a wavelength input into optically active region 528 may correspond to the various energy differences between conductance bands and valence bands or the transition between discretized energy states of different carriers. When the various energy differences are stimulated by absorbing photons of the input light, different light generation can occur at different wavelengths thereby generating a lasing mode along with one or more secondary modes.

Another example mechanism for injection seeing is that resonator structure 501 has discrete modes that may resonant therein, for example, at resonance frequencies separated by an integer of FSRs of the resonator structure 501. The input signal may act as a seed signal for stimulating a number of lasing modes. However, at optical power levels below the threshold optical power, only light at a wavelength of a central lasing mode of the optical gain mechanism 504 resonates with sufficient optical power to create lasing conditions so that the lasing mode of 504 is emitted from the output end of bus waveguide 510. At optical power levels equal to or above the threshold optical power, lasing conditions for the one or more secondary modes are created, resulting in the sudden appearance of the one or more secondary modes at the output.

As yet another example mechanism, the appearance of the secondary modes may be due to photons of the input signal at a specific wavelength causing an increase in the stimulated emission of photons within the resonator structure 501 resonating at different wavelengths. The injected photons may induce heating of waveguide 502 that causes a slight shift in the refractive index of the waveguide 502 such that various different lasing modes resonating within the resonator structure 501.

While certain materials are described as negatively- or positively-doped, implementations are not limited thereto, and the polarity doping may be switched. For example, while the above example described the cathode 526 as negatively-doped and the anode 532 and doped semiconductor layer 534 as positively-doped, the polarity of each layer may be switched such that the cathode 526 is positively-doped and the anode 532 and semiconductor layer 534 may be negatively-doped.

FIG. 6 illustrates a schematic diagram of an example system architecture 600 for a neuron according to implementations disclosed herein. System 600 includes a source signal 610, an optical interference unit 620, and optical nonlinearity unit 630. In the example implementation of FIG. 6, the source signal 610 may be provided by a comb laser 612. The optical interference unit 620 comprises a microring modulator array 622 to encode an input signal (e.g., X₁-Xₙ of FIG. 1) onto input optical signals, and a memristive Mach-Zehnder Interferometer (MZI) mesh 624 that applies a weight matrix to the input signals by tuning of optical interference according to weights of the weight matrix. In the example of FIG. 6, MZI mesh 624 is an 8×8 MZI mesh, but meshes are possible based on the dimensions of a weight matrix. The optical nonlinearity unit 630 comprises a plurality of optical devices 632, each of which may be implemented as an optical device 200 of FIG. 2.

In system 600, multiple wavelengths of light are coupled on-chip to the array 622 of microring modulators. Microring modulator array 622 are used to multiplex the light into different channels and then modulate an input data stream onto each channel. Next, the signal is coupled into the memristive MZI mesh 624, where the weights are applied to the input signal through the form of phase shifts induced by each memristor (e.g., U_{n,n}). The output of the MZI mesh 624 is input into optical devices 632 for optical injection locking. Once the amount of power injected into the optical devices 632 reaches the threshold optical power at a specific wavelength for each optical device 632 (e.g., a wavelength that resonant within each optical device 632), each optical devices 632 will begin lasing at one or more secondary modes and output a wavelength corresponding to the one or more secondary modes. In the illustrative example of FIG. 6, each output from the MZI mesh 624 is coupled to a plurality of optical devices 632 (e.g., 8 in this example). Each optical device 632 has different resonant frequencies and generate different central lasing modes. Thus, each optical device 632 is able to generate different secondary modes in order to effectuate the decision of the neuron.

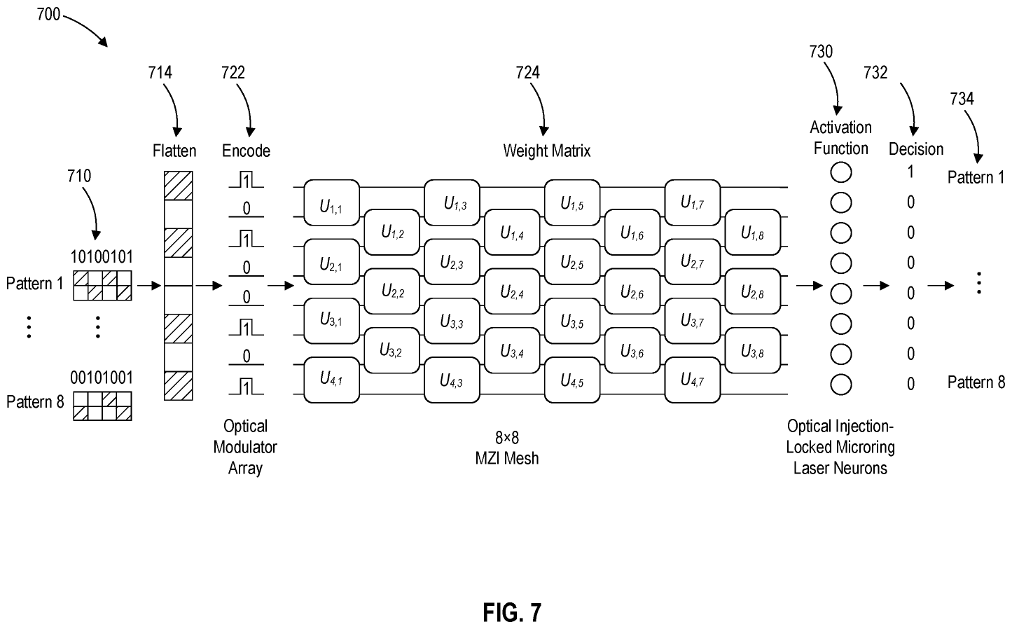

FIG. 7 is a demonstration of an example neural network 700 using the system 600 of FIG. 6. That is, source signal 610 provides an input pattern 710, which may be based on a preceding neuron or the comb laser 612. The optical interference unit 620 encodes optical modular array 722 the input pattern onto optical signals, which are input into the MZI mesh 624 as the weight matrix 724. The activation function 730 of the neuron is performed by optical nonlinearity unit 630 to output a decision 732, which is translated into output patterns 734. Output patterns 734 may be used as input patterns for a subsequent neuron.

For example, input pattern 710 may include eight 2×4 patterns with black or white pixels to be recognized. The input patterns 710 are flattened into an 8-entry vector 714, which is encoded onto optical modular array 722 by modulating a single wavelength signal from a laser (e.g., comb laser 612) using optical microring modulators for microring modulator array 622. The encoded optical signals are input into the MZI mesh 624, and the output of the MZI mesh 624 is used to injection-lock the optical devices 632, as described above, which act as an all-optical nonlinear activation function 730. Decision 732 can be made by detecting the output of the optical devices 632, to generate output patterns 734 recognized by training the weight matrix in the MZI mesh 624.

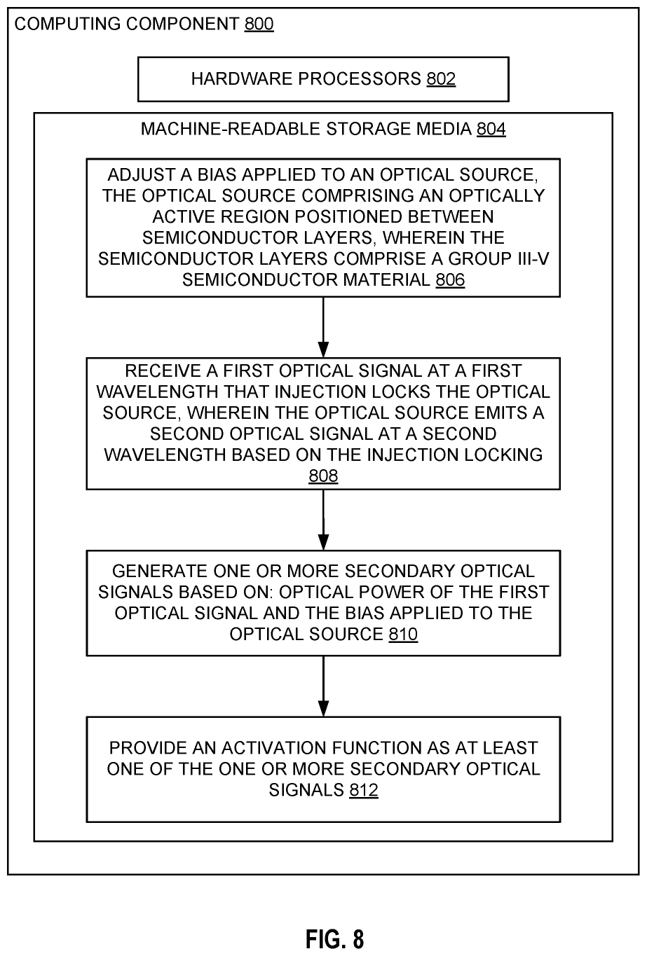

FIG. 8 illustrates an example computing component that may be used to operate a nonlinear activation function in accordance with various embodiments. Referring now to FIG. 8, computing component 800 may be, for example, a server computer, a controller, or any other similar computing component capable of processing data. In the example implementation of FIG. 8, the computing component 800 includes a hardware processor 802, and machine-readable storage medium for 804.

Hardware processor 802 may be one or more central processing units (CPUs), semiconductor-based microprocessors, and/or other hardware devices suitable for retrieval and execution of instructions stored in machine-readable storage medium 804. Hardware processor 802 may fetch, decode, and execute instructions, such as instructions 806-812, to control processes or operations for operating a nonlinear activation function, such as those described in connection with FIGS. 2 and 5A-7. As an alternative or in addition to retrieving and executing instructions, hardware processor 802 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 804, may be any electronic, magnetic, optical, or other physical storage device that contains or stores executable instructions. Thus, machine-readable storage medium 804 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 804 may be a non-transitory storage medium, where the term “non-transitory” does not encompass transitory propagating signals. As described in detail below, machine-readable storage medium 804 may be encoded with executable instructions, for example, instructions 806-812.

Hardware processor 802 may execute instruction 806 to adjust a bias applied to an optical source, where the optical source comprises an optically active region positioned between semiconductor layers that comprise a Group III-V semiconductor material. For example, the optical source may be implemented as optical device 200 of FIG. 2 and/or optical device 500 of FIGS. 5A and 5B. As described above, a bias current may be applied to the optical source that, when adjusted to be at or above a threshold current, drives an optically active region in stimulated emission operation.

Hardware processor 802 may execute instruction 808 to receive a first optical signal at a first wavelength that injection locks the optical source, where the optical source emits a second optical signal at a second wavelength based on injection locking. For example, while operating in stimulated emission, an input signal may be provided to the optical source that injection locks the optically active region, and stimulating emission of the second wavelength. As described above, the first optical signal (e.g., a master lasing mode) may be provided to a bus waveguide (e.g., bus waveguide 210 and/or 510). The first optical signal may couple into a resonator structure (e.g., resonator structure 201 and/or 501), which supplies the first optical signal to an optical gain mechanism (e.g., optical gain mechanism 204 and/or 504). The first optical signal may injection lock the optically active region of the optical gain mechanism, which causes stimulated emissions of the second optical signal (e.g., a slave lasing mode).

Hardware processor 802 may execute instruction 810 to generate one or more secondary optical signals based on the optical power of the first optical signal and the bias applied to the optical source. For example, the first optical signal has an associated optical power. If that optical power is increased to or above a threshold optical power, one or more secondary modes are stimulated in the optically active region, which are emitted into the resonator structure and output from the bus waveguide. Prior to the optical power reaching the threshold optical power, the one or more secondary modes may not exist or may not have sufficient power to resonant in the optical device and create lasing conditions for the one or more secondary modes.

Hardware processor 802 may execute instruction 812 to provide an activation function as at least one of the one or more secondary optical signals. For example, as described above, the optical power of the first optical signal may be based on a weighted summation of a neuron. The optical power of the first optical signal maybe increased according to the weighted summation such that the optical power reaches the threshold optical power when the weighted summation reaches conditions for activating the neuron. Responsive to the optical power reaching the threshold optical power, the one or more secondary modes are stimulated and are emitted by the optical source. The one or more secondary modes, at wavelengths that are different from the first and second optical signals, can be monitored and used for activating the neuron in making decisions of a neuromorphic computation system.

FIG. 9 depicts a block diagram of an example computer system 900 in which various of the embodiments described herein may be implemented. The computer system 900 may be implemented, for example, to control one or more of the power source 560 or other components of a neuron and/or neuromorphic computation system (e.g., system 600), one or more hardware processors 904 coupled with bus 902 for processing information. Hardware processor(s) 904 may be, for example, one or more general purpose microprocessors.

The computer system 900 also includes a main memory 906, such as a random access memory (RAM), cache and/or other dynamic storage devices, coupled to bus 902 for storing information and instructions (e.g., instructions 806-812) to be executed by processor 904. Main memory 906 also may be used for storing temporary variables or other intermediate information during execution of instructions to be executed by processor 904. Such instructions, when stored in storage media accessible to processor 904, render computer system 900 into a special-purpose machine that is customized to perform the operations specified in the instructions.

The computer system 900 further includes a read only memory (ROM) 908 or other static storage device coupled to bus 902 for storing static information and instructions for processor 904. A storage device 910, such as a magnetic disk, optical disk, or USB thumb drive (Flash drive), etc., is provided and coupled to bus 902 for storing information and instructions.

The computer system 900 may be coupled via bus 902 to a display 912, such as a liquid crystal display (LCD) (or touch screen), for displaying information to a computer user. An input device 914, including alphanumeric and other keys, is coupled to bus 902 for communicating information and command selections to processor 904. Another type of user input device is cursor control 916, such as a mouse, a trackball, or cursor direction keys for communicating direction information and command selections to processor 904 and for controlling cursor movement on display 912. In some embodiments, the same direction information and command selections as cursor control may be implemented via receiving touches on a touch screen without a cursor.

The computing system 900 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 900 may implement the techniques described herein using customized hard-wired logic, one or more ASICs or FPGAs, firmware and/or program logic which in combination with the computer system causes or programs computer system 900 to be a special-purpose machine. According to one embodiment, the techniques herein are performed by computer system 900 in response to processor(s) 904 executing one or more sequences of one or more instructions contained in main memory 906. Such instructions may be read into main memory 906 from another storage medium, such as storage device 910. Execution of the sequences of instructions contained in main memory 906 causes processor(s) 904 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 910. Volatile media includes dynamic memory, such as main memory 906. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 902. Transmission media can also take the form of acoustic or light waves, such as those generated during radio-wave and infra-red data communications.

The computer system 900 also includes a communication interface 918 coupled to bus 902. Network interface 918 provides a two-way data communication coupling to one or more network links that are connected to one or more local networks. For example, communication interface 918 may be an integrated services digital network (ISDN) card, cable modem, satellite modem, or a modem to provide a data communication connection to a corresponding type of telephone line. As another example, network interface 918 may be a local area network (LAN) card to provide a data communication connection to a compatible LAN (or WAN component to communicated with a WAN). Wireless links may also be implemented. In any such implementation, network interface 918 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through communication interface 918, which carry the digital data to and from computer system 900, are example forms of transmission media.

The computer system 900 can send messages and receive data, including program code, through the network(s), network link and communication interface 918. In the Internet example, a server might transmit a requested code for an application program through the Internet, the ISP, the local network and the communication interface 918.

The received code may be executed by processor 904 as it is received, and/or stored in storage device 910, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

As used herein, a circuit might be implemented utilizing any form of hardware, software, or a combination thereof. For example, one or more processors, controllers, ASICs, PLAS, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 900.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method of operating a nonlinear activation device, the method comprising:
adjusting a bias applied to an optical source, the optical source comprising an optically active region positioned between semiconductor layers, wherein the semiconductor layers comprise a Group III-V semiconductor material;
receiving a first optical signal at a first wavelength that injection locks the optical source, wherein the optical source emits a second optical signal at a second wavelength based on injection locking;
generating one or more secondary optical signals based on: optical power of the first optical signal and the bias applied to the optical source; and
providing an activation function as at least one of the one or more secondary optical signals.

2. The method of claim 1, wherein the optically active region comprises at least one of quantum dots, quantum wells, and quantum-dash structures.

3. The method of claim 1, further comprising operating the optical source in a stimulated emission region of an optical response based on the bias.

4. The method of claim 1, wherein the second wavelength differs from the first wavelength.

5. The method of claim 1, wherein the one or more secondary optical signals propagate at one or more wavelengths that are different from the first and second wavelengths.

6. The method of claim 1, wherein the one or more secondary optical signals comprises a first secondary optical signal of the first optical signal and a second secondary optical signal of the second optical signal.

7. The method of claim 1, further comprising driving the optically active region in stimulated emission operation responsive to adjusting the bias applied equal to or above a threshold bias.

8. The method of claim 1, wherein generating the one or more secondary optical signals is responsive to the optical power of the first optical signal being equal to or above a threshold optical power.

9. The method of claim 1, wherein the first optical signal is received on a bus waveguide that is evanescently coupled to a resonator structure comprising an optical gain mechanism, wherein the optical gain mechanism comprises:
a cathode formed on the waveguide;
a mesa structure formed on the cathode, the mesa structure comprising the optically active region; and
an anode formed on the mesa structure,
wherein the optically active region emits the second optical signal based on the bias applied between the cathode and the anode and generates the one or more secondary optical signals responsive to the optical power of the first optical signal being equal to or above a threshold optical power.

10. A neuromorphic computation system, comprising:
an optical interference unit configured to encode input data onto a plurality of input optical signals, apply a weight matrix to the plurality of input optical signals by tuning optical interference, and output a plurality of weighted optical signals; and
an optical nonlinearity unit configured to provide a nonlinear activation function based on a weighted summation output from the optical interference unit, the optical nonlinearity unit comprising a plurality of injection locked resonator cavity lasers configured to generate one or more secondary lasing modes responsive to optical power of the plurality of weighted optical signals being at or above a threshold optical power.

11. The neuromorphic computation system of claim 10, wherein the plurality of injection locked resonator cavity lasers are injection locked based on a bias applied that drives the injection locked resonator cavity lasers in stimulated emission operation.

12. The neuromorphic computation system of claim 10, wherein the optical interference unit and the optical nonlinearity unit are formed on a common substrate of a semiconductor platform.

13. The neuromorphic computation system of claim 10, wherein each of the injection locked resonator cavity lasers is configured to:
receive a weighted optical signal of the plurality of weighted optical signals comprising at least a first lasing mode at a first wavelength;
emit a second lasing mode at a second wavelength based on receiving the first lasing mode; and
responsive to the first lasing mode having an optical power at or above the threshold optical power, generate the one or more secondary lasing modes at one or more wavelengths that differ from the first and second wavelengths.

14. The neuromorphic computation system of claim 10, wherein each of the injection locked resonator cavity lasers comprises:
a bus waveguide configured to receive a weighted optical signal of the plurality of weighted optical signals comprising at least a first lasing mode; and
a resonator structure optically coupled to the bus waveguide and comprising an optical gain mechanism configured to emit a second lasing mode and the one or more secondary lasing modes.

15. The neuromorphic computation system of claim 10, further comprising a plurality of neuron, at least one neuron of the plurality of neuron comprising the optical interference unit and the optical nonlinearity unit, wherein the plurality of neurons are formed on a common substrate of a semiconductor platform.

16. A nonlinear activation device comprising:
a bus waveguide configured to receive a first lasing mode having an optical power that is based on a weighted summation of a neuron;
a resonator structure optically coupled to the bus waveguide and comprising an optical gain mechanism configured to emit a second lasing mode based on injection locking to the first lasing mode and one or more secondary lasing modes based on injection locking to the first lasing mode and based on the optical power of the first lasing mode; and
the bus waveguide configured to output an activation function based on at least one of the one or more secondary lasing modes.

17. The nonlinear activation device of claim 16, wherein the resonator structures is a microring resonator structure.

18. The nonlinear activation device of claim 16, wherein the optical gain mechanism comprises:
a cathode formed on a waveguide of the resonator structure;
a mesa structure formed on the cathode, the mesa structure comprising an optically active region formed between a first Group III-V semiconductor material layer and a second Group III-V semiconductor material layer; and
an anode formed on the mesa structure,
wherein the optically active region generates the second lasing mode based on injection locking to the first lasing mode responsive to a bias applied to the cathode and the anode being equal to or above a threshold bias and generates the one or more secondary lasing responsive to the optical power of the first lasing mode equal to or above a threshold optical power.

19. The nonlinear activation device of claim 18, wherein the optically active region comprises one or more of quantum dots, quantum wells, and quantum-dash structures.

20. The nonlinear activation device of claim 16, wherein the nonlinear activation device is formed as part of the neuron on a common substrate of a semiconductor platform.
